(19) United States
(12) Patent Application Publication
(10) Pub. No.: US 2006/0148444 A1
(43) Pub. Date: Jul. 6, 2006

(54) Home network system and method for providing user interfaces

(75) Inventors: Jun-hyeong Kim, Anyang-si (KR); Moon-jeong Choi, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/290,415

(22) Filed: Dec. 1, 2005

(30) Foreign Application Priority Data
Jan. 5, 2005 (KR) 2005-873

(51) Int. Cl. H04Q 7/20

(52) U.S. Cl. 455/403

(57) ABSTRACT

A method for establishing a user interface suitable for plural clients each having a different user interface is provided. In a home network including a service server and at least one client, the client requests a user interface generator from the service server, and a client profile to the service server. The client receives a modified user interface generator suitable for the client profile, and creates a user interface using the modified user interface generator. If the client can not create the user interface, the service server or the client may request a user interface generation unit to create the user interface.

### CROSS-REFERENCE TO RELATED APPLICATIONS

This application claims priority under 35 U.S.C. § 119 from Korean Patent Application No. 10-2005-0000873, filed on Jan. 5, 2005, the entire contents of which are incorporated herein by reference.

### BACKGROUND OF THE INVENTION

1. Field of the Invention

Apparatuses and methods consistent with the present invention relate to user interfaces used for a home network and more particularly, providing and establishing user interfaces suitable for environments of clients sending control commands to a service server.

2. Description of the Related Art

A home network is an electronic appliance system of the future capable of connecting home appliances such as TVs, refrigerators, air conditioners, and on the like, and home spaces such as a master room, kitchen, living room, front door, and on the like, through the Internet, so that a user can manage the appliances and home spaces through a hand-held phone or the like.

A home network user can monitor her home, can adjust home temperatures at her office, and can automatically take her health examination, by using a PDA or hand-held phone, similar to controlling a TV with a remote controller. For example, a TV may turn on by checking whether a person who is turning on the TV is a home network user, through the fingerprint recognizer of a remote controller. A variety of information can also be provided to the user. Traffic conditions for commuting can be checked according to information provided in real time by a traffic information service provider, and a user can determine commuting routes accordingly.

Wireless and wired technologies for home network interfaces each have benefits and drawbacks. Home PNA, IEEE1394, PLC, ethernet, and the like may be used for wired technology, and Bluetooth, home RF, IrDA, and for the like may be used for the wireless technology. Wired home network technology has the advantage of free information sharing using a single protocol to control computers, peripherals, information devices, digital appliances, and on the like. However, wireless technology has the advantage of requiring no cable wiring and of guaranteed terminal mobility. Further, wireless technology has the advantage of enabling simple changes to the network structure and simple installation and maintenance as compared to wired technology, but has the disadvantage of possible transmission error due to interference and attenuation of identical frequencies, or security problems, and on the like. Home RF and Bluetooth utilize radio waves, and IrDA utilizes infrared rays. Infrared rays have the advantage of avoiding interference due to radio waves, but have the disadvantage of a short distance range. Compared to infrared rays, radio waves have the advantage of a long distance range, but also have less security.

FIG. 1 shows a typical home network. In FIG. 1, the home network has at least one service server 100 and a plurality of clients 110 to 116. The home network may also have a plurality of home appliances which can be controlled by the service server 100. Further, the service server and a client can interchange their services depending on situations and functions. That is, a client may function as a service server which provides services, or a service server may function as a client which requests services.

With reference to FIG. 1, the service server 100 receives a control command from the clients 110 to 116, and provides services or controls home appliances according to the received control command. The clients 110 to 116 are served, or send necessary control commands to the service server 100 to control home appliances connected to the service server 100.

In general, user interfaces, which can be supported by clients in a home network, differ depending on the type of client. Thus, a service server has to be able to support the varying types of user interfaces that the plural clients can support. Further, a service server must have access to information relating to the user interfaces that the individual clients support.

### SUMMARY OF THE INVENTION

An exemplary aspect of the present invention is to provide a method for providing user interfaces suitable for plural clients each having a different user interface.

Another exemplary aspect of the present invention is to provide a method for providing a user interface necessary for a client even when the client can not create the user interface.

According to an aspect of the present invention, there is provided, a method for establishing a user interface in a client, comprising: requesting a user interface generator from a service server; sending a client profile to the service server; receiving a modified user interface generator suitable for the client profile; and generating a user interface using the received user interface generator.

According to an aspect of the present invention, there is provided, a method for establishing a user interface in a client, comprising: requesting a user interface generator from a service server; transmitting a client profile to the service server; and receiving a user interface suitable for the client profile.

According to an aspect of the present invention, there is provided, a user interface-establishing system, comprising at least one client and a user interface generation unit. The client comprises means for requesting a user interface and means for transmitting a client profile. The user interface generation unit comprises means for creating a user interface to be provided to the client according to the client profile.

According to an aspect of the present invention, there is provided, a user interface-establishing system, comprising at least one client, a service server, and a user interface generation unit. The client comprises means for transmitting a received user interface generator, and means for requesting creation of a user interface in accordance with the user interface generator. The service server comprises means for transmitting a modified user interface generator suitable for a client profile received from the client. The user interface generation unit comprises means for creating a user interface according to the client profile.

### BRIEF DESCRIPTION OF THE DRAWINGS

The above aspects of the present invention will become more apparent by the following detailed description of exemplary embodiments of the present invention with reference to the accompanying drawings, in which:

FIG. 1 shows a general home network structure;

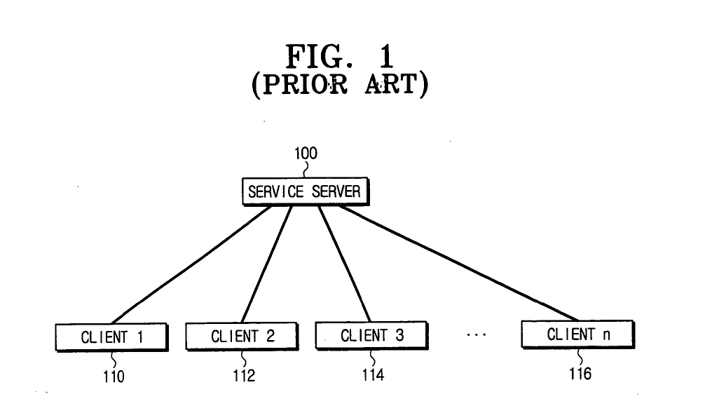

FIG. 2 shows a process for receiving a user interface from a client which can create a user interface;

FIG. 3 shows a process for receiving a user interface from a client which can not create a user interface;

FIG. 4 shows a process for receiving a user interface from a client which can not create a user interface;

FIG. 5 shows a client structure according to an exemplary embodiment of the present invention;

FIG. 6 shows operations of a client according to an exemplary embodiment of the present invention;

FIG. 7 shows a service server structure according to an exemplary embodiment of the present invention;

FIG. 8 shows operations of a service server according to an exemplary embodiment of the present invention;

FIG. 9 shows a structure of a user interface generation unit according to an exemplary embodiment of the present invention; and

FIG. 10 shows operations of the user interface generation unit according to an exemplary embodiment of the present invention.

### BRIEF DESCRIPTION OF EXEMPLARY EMBODIMENTS OF THE PRESENT INVENTION

Hereinafter, exemplary embodiments of the present invention will be described in detail with reference to the accompanying drawings.

For simplicity and clarity, well-known functions or constructions are not described in detail herein.

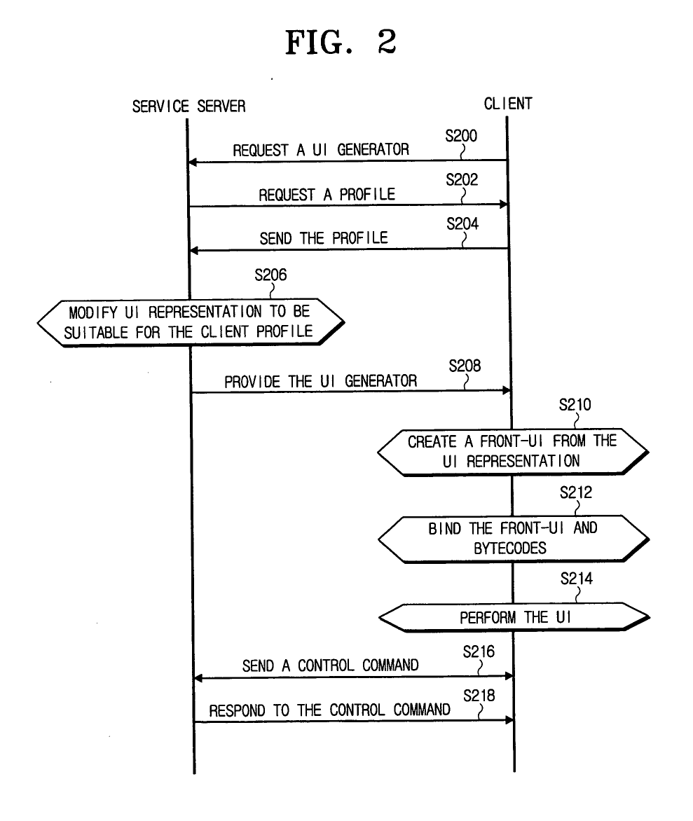

FIG. 2 shows a process for receiving a user interface from a client which can create a user interface. According to an exemplary embodiment of the present invention, a client may request a user interface generator, necessary to create a user interface, from a service server rather than requesting the user interface itself. A user interface generator generates a user interface which a client uses to send control commands to the service server. A user interface has a user interface representation (UI representation) and bytecodes. The user interface representation creates a front user interface which is suitable for input/output environments of varying client devices. Markup Language and or like is used to abstractly code a user interface which enables a user to interact with the service server regardless of the varying input/output schemes provided by a client. Bytecodes are codes which can be executed based on virtual machines, such as Java Virtual Machine (JVM) and on the like, which implement functions to be carried out in a client, functions necessary to communicate with the service server, or the like. In particular, it is assumed that the client of FIG. 2 can generate a user interface through the use of a user interface generator received from a home server.

In operation S200, the client requests a user interface generator from the server. In operation S202, the service server requests a client profile from the client in order to send a user interface generator suitable for the client. In operation S204, the client sends its own profile to the service server according to the request of the service server. For example, the client may send the service server his own profile: “Win2000, Java 2 Standard Edition (J2SE), UIML2Java Renderer, Java-AWT, No bytecode Translation”. This exemplary profile indicates that the client uses Windows 2000 and Java-AWT for UI, and has functionality for creating a Java-AWT user interface from a user interface representation coded in UIML. Further, the profile indicates that the client does not have functionality for translating the bytecodes to be suitable for a virtual machine of the client. That is, the client does not have functionality for translating bytecodes executable in an A-type virtual machine in order to be executable in a B-type virtual machine.

In operation S206, the service server modifies a UI representation to suit the received client profile. A general user interface representation includes portions for generating a WML UI, a VoiceXML UI, and on the like, in addition to portions for generating a Java-AWT UI. Therefore, the service server modifies the general UI representation to remove all portions except for the necessary portions for generating a Java-AWT UI. Thus, network resources used to send the user interface generator to the client may be saved, and unnecessary work by the client in removing unnecessary portions may be avoided. In operation S208, the service server sends the user interface generator to the client. For example, the service server sends the user interface representation suitable for the java-AWT environments and the bytecodes suitable for J2SE environments.

In operation S210, the client creates a front user interface (Front-UI) suitable for the java-AWT UI environments from the user interface representation of the received user interface generator. In operation S212, the client fills the user interface with content (executable user interface creation). That is, the client connects the executable bytecodes included in the user interface generator to the Front-UI. The bytecodes include functions the client has to execute, functions necessary to communicate with the service server, or the like, and a network protocol used for communications with the service server.

In operation S214, the client executes the generated user interface. In operation S216, the client sends a control command to the service server through the user interface. In operation S218, the service server responds to the control command. As stated above, the service server receives a client profile from the client and provides the client with a user interface generator suitable for the client, and the client uses the received user interface generator to create a user interface that can send a control command to the service server.

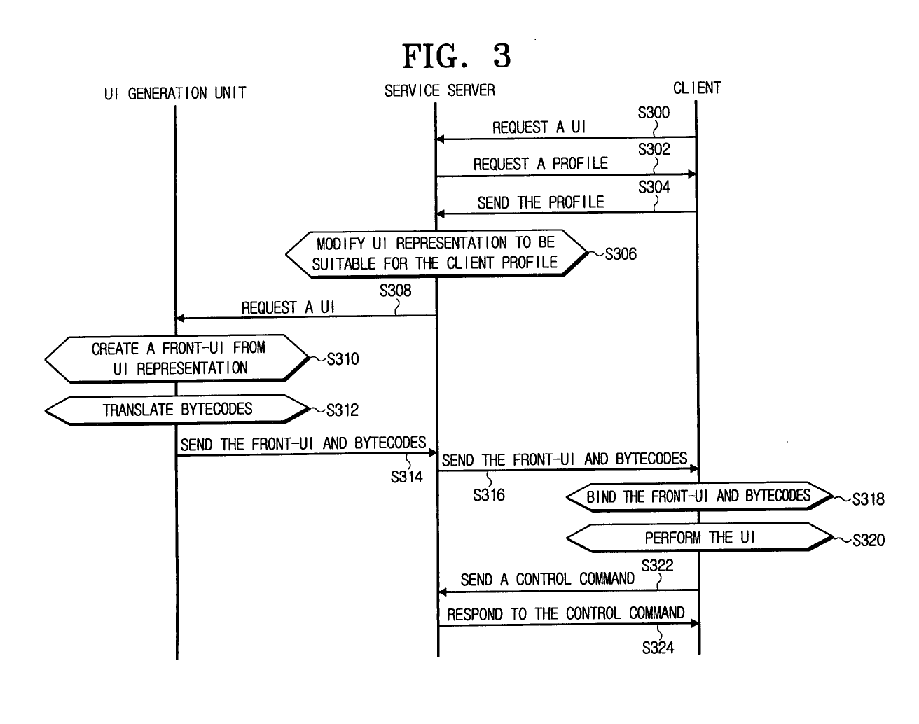

FIG. 3 explains a process for a client receiving a user interface from the service server according to an exemplary embodiment of the present invention. According to the exemplary embodiment illustrated in FIG. 3, the client can not create a user interface by using a user interface generator. Hereinafter, description will be made of a process in which a client receives a user interface in accordance with FIG. 3.

In operation S300, the client requests a user interface from the service server. Unlike in FIG. 2, the client can not create a user interface on its own and therefore, the client requests a user interface from the server. In operation S302, the home server requests a profile from the client, and in operation S304, the client sends the profile to the service server. The profile includes information regarding the operating system (OS), virtual machine, renderer, UI toolkit, bytecode translator, and on the like of the client. For example, the client may send the service server: “WinCE, connected limited device configuration (CLDC), No Renderer, MIDP-UI, No bytecode Translation”. This profile indicates that the client uses WinCE and MIDP-UI.

In operation S306, the home server modifies the user interface representation to suit the profile received from the client. That is, the home server modifies the user interface representation to create an MIDP-UI representation. In operation S308, the service server transmits a request to the UI generation unit to generate a user interface. Specifically, the service server sends the profile received from the client and a user interface generator for generating a user interface to the UI generation unit. The user interface generator includes a UI representation for the MIDP-UI and Java bytecodes for J2ME CLDC.

In operation S310, the UI generation unit uses the UI representation to generate a Front-UI. In operation S312, the UI generation unit translates the bytecodes provided by the service server into bytecodes suitable for the Virtual Machine of the client. In this embodiment, the J2ME CLDC bytecodes provided by the service server have already been modified to suit the client; thus, translations of the bytecodes are not substantially required. In operation S314, the UI generation unit sends the service server the Front-UI, created in operation S310 and the CLDC bytecodes translated in the operation S312 to the service server.

In operation S316, the service server sends the Front-UI and the CLDC bytecodes to the client. In operation S318, the client binds the received Front-UI and the CLDC bytecodes. That is, the client fills the user interface with content (creation of an executable user interface).

In operation S320, the client executes the created user interface; in operation S322, the client sends a control command to the service server by using the user interface; and in operation S324, the service server responds to the control command.

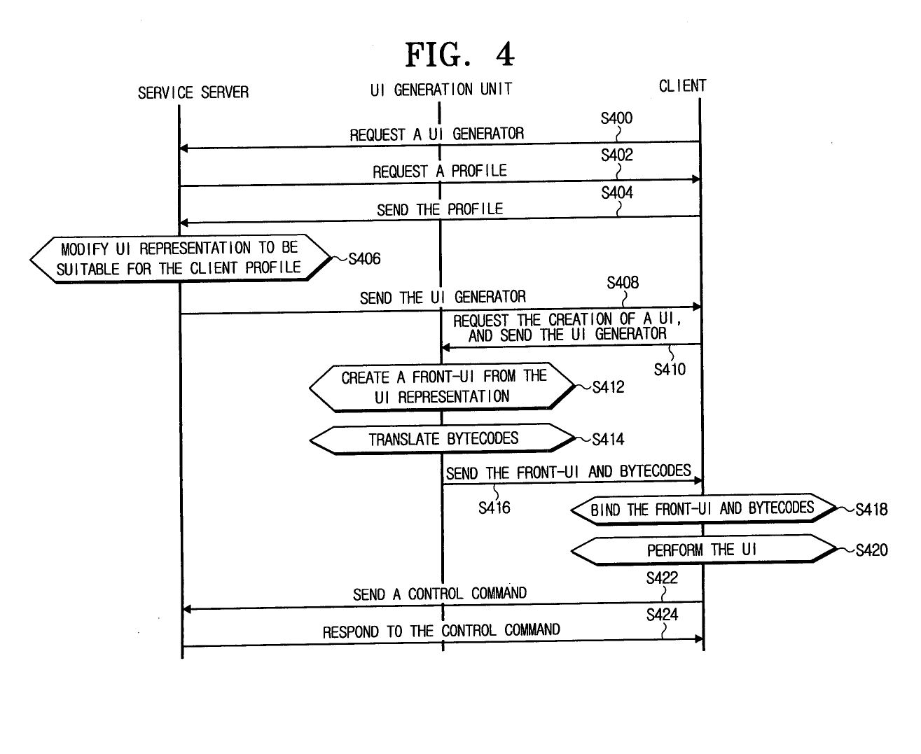

FIG. 4 explains another process for a client receiving a user interface from the service server according to an exemplary embodiment of the present invention. According to the exemplary embodiment illustrated in FIG. 4, the client can not generate a user interface by using a user interface generator. Hereinafter, description will be made of a process in which a client receives a user interface in accordance with FIG. 4.

In operation S400, the client requests a user interface generator from the service server. In operation S402, the service server requests a profile from the client, and in operation S404, the client sends the profile to the service server.

In operation S406, the service server modifies the user interface generator to suit the client profile. In operation S408, the service server sends the user interface generator to the client.

In operation S410, the client sends the user interface generator to the UI generation unit, and requests the UI generation unit to create a user interface using the transmitted user interface generator. In operation S412, the UI generation unit creates a Front-UI from the UI representation. In operation S414, the UI generation unit translates bytecodes. In operation S416, the UI generation unit sends the Front-UI created in the operation S412 and the bytecodes translated in the operation S414 to the client.

In operation S418, the client binds the received Front-UI and the translated bytecodes. In operation S420, the client executes the created user interface; in operation S422, the client sends the service server a control command by using the user interface; and in operation S424, the service server responds to the control command.

FIG. 3 and FIG. 4 show that the home server and the UI generation unit may be separately configured. However, they can also be integrated into a single configuration.

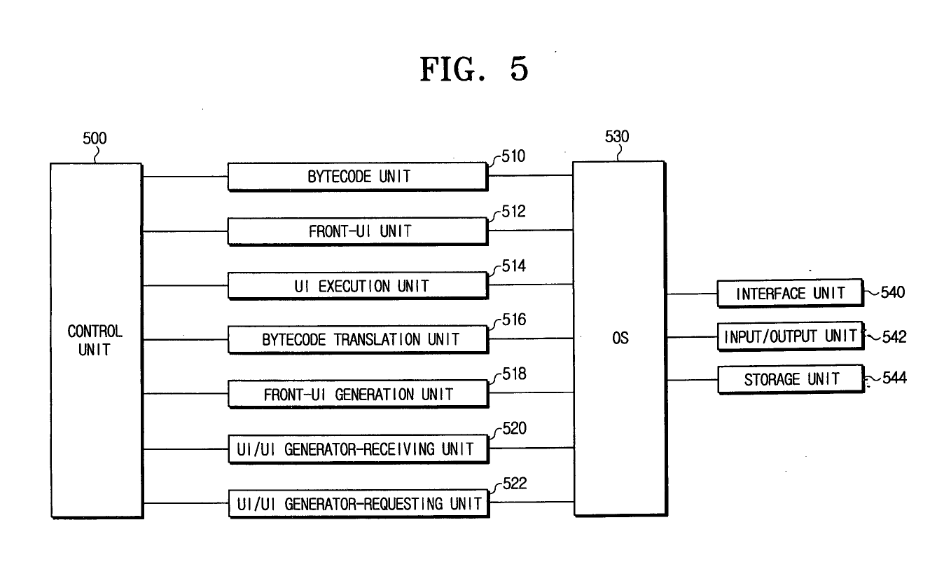

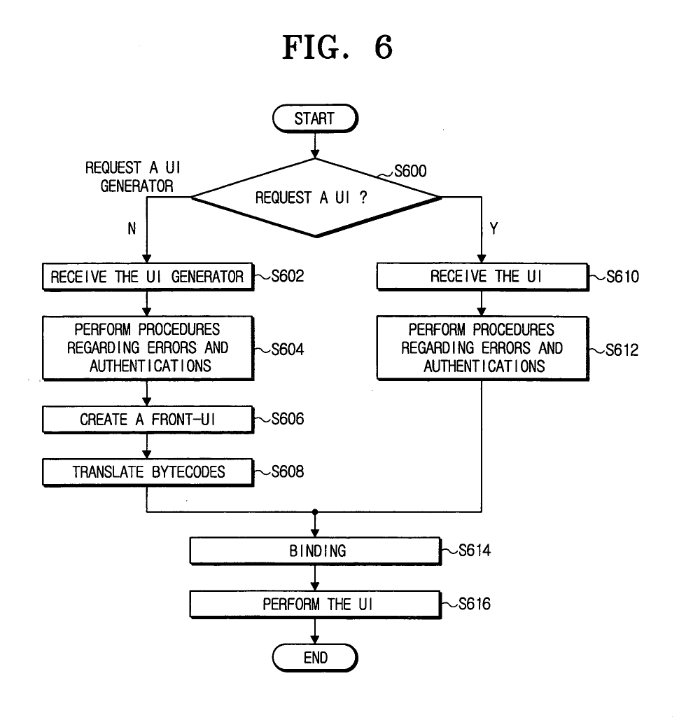

FIG. 5 shows a client structure according to an exemplary embodiment of the present invention, and FIG. 6 shows operations of the client.

With reference to FIG. 5, a client includes a control unit 500, a bytecode unit 510, a Front-UI unit 512, a UI execution unit 514, a bytecode translation unit 516, a Front-UI generation unit 518, a UI/UI generator-receiving unit 520, a UI/UI generator-requesting unit 522, an OS 530, an interface unit 540, an input/output unit 542, and a storage unit 544.

The control unit 500 controls the respective units constituting the client. The bytecode unit 510 stores bytecodes translated in the bytecode translation unit 516, and the Front-UI unit 512 stores a Front-UI created in the Front-UI generation unit 518. The UI execution unit 514 executes a UI using the created UI. The bytecode translation unit 516 translates the received bytecodes into bytecodes that the bytecode translation unit 516 can support. The UI/UI generator-receiving unit 520 receives a UI/UI generator from the home server or the UI generation unit. The UI/UI generator-requesting unit 522 requests a UI/UI generator from the home server or the UI generation unit.

The OS 530 interfaces between hardware components and application programs. The interface unit 540 connects clients to the service server as well as connecting clients to the UI generation unit. The input/output unit 542 may include a display device, a keyboard, and on the like. The storage unit 544 can store general information on clients, or information necessary for client operations.

With reference to FIG. 6, in operation S600, the client determines whether to request a user interface (UI). If the client can create a UI, the client requests a UI generator, and if the client can not generate a UI, the client requests a UI. That is, if the client can generate a UI, the client runs operation S602, and, if the client can not generate a UI, the client runs operation S610.

In operation S602, the client receives the UI generator, and in operation S604, the client performs procedures regarding errors in and authentications for the UI generator. The client determines whether the received UI generator is sent from a corresponding service server. In operation S606, the client creates a Front-UI, and in operation S608, the client translates bytecodes.

In the operation S610, the client receives a UI, and in operation S612, the client checks errors and security regarding the received UI. In operation S614, the client binds the received Front-UI and translated bytecodes. That is, the client fills the user interface with content (creation of an executable user interface). In operation S616, the client runs the created user interface.

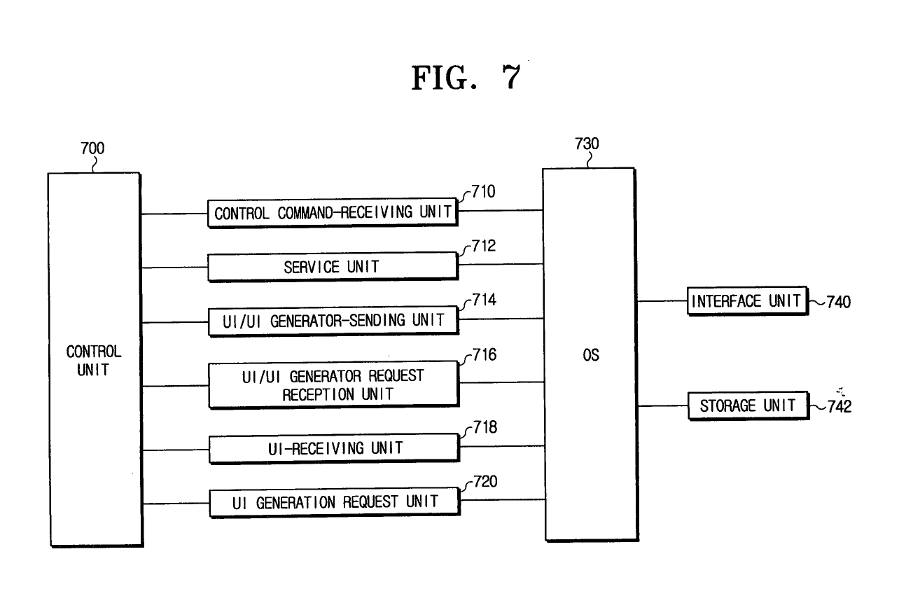

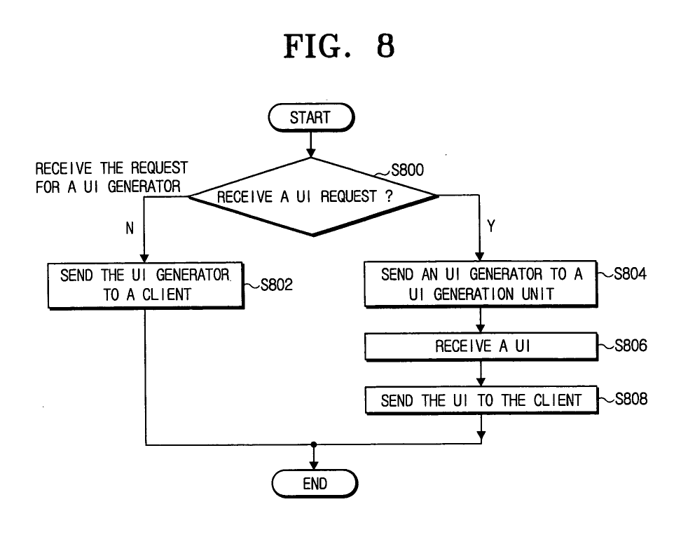

FIG. 7 shows a structure of a service server according to an exemplary embodiment of the present invention. FIG. 8 shows operations of the service server.

With reference to FIG. 7, the service server includes a control unit 700, a control command-receiving unit 710, a service unit 712, a UI/UI generator-sending unit 714, a UI/UI generator request reception unit 716, a UI-receiving unit 718, a UI generation-requesting unit 720, an OS 730, an interface unit 740, and a storage unit 742.

The control unit 700 controls the respective units constituting the service server. The control command-receiving unit 710 receives control commands sent from the client. The service unit 712 provides corresponding services according to the control commands sent from the control command-receiving unit 710. The UI/UI generator-sending unit 714 sends a UI/UI generator to the UI generation unit or to the client. The UI/UI generator request reception unit 716 receives a request from the UI/UI generator from the UI generation unit or the client. The UI-receiving unit 718 receives a UI from the UI generation unit. The UI generation-requesting unit 720 requests the UI generation unit to generate an UI.

The OS 730 interfaces between hardware components and application programs. The interface unit 740 connects the service server to clients as well as connecting the service server to the UI generation unit. The storage unit 742 can store general information on the service server or information necessary for service server operations. Further, the storage unit 742 stores a UI representation and bytecodes.

With reference to FIG. 8, in operation S800, the service server determines whether a request for a UI has been received. If the service server receives a UI request, the service server runs operation S804, and if the service server receives a request for a UI generator, the service server runs operation S802. In operation S802, the service server sends a UI generator to the client.

In operation S804, the service server sends a UI generator to the UI generation unit, and requests the UI generation unit to create a UI. Specifically, if the service server creates a UI, the service server creates and sends the requested UI to the client. In operation S806, the service server receives the UI from the UI generation unit, and in operation S808, the service server sends the received UI to the client.

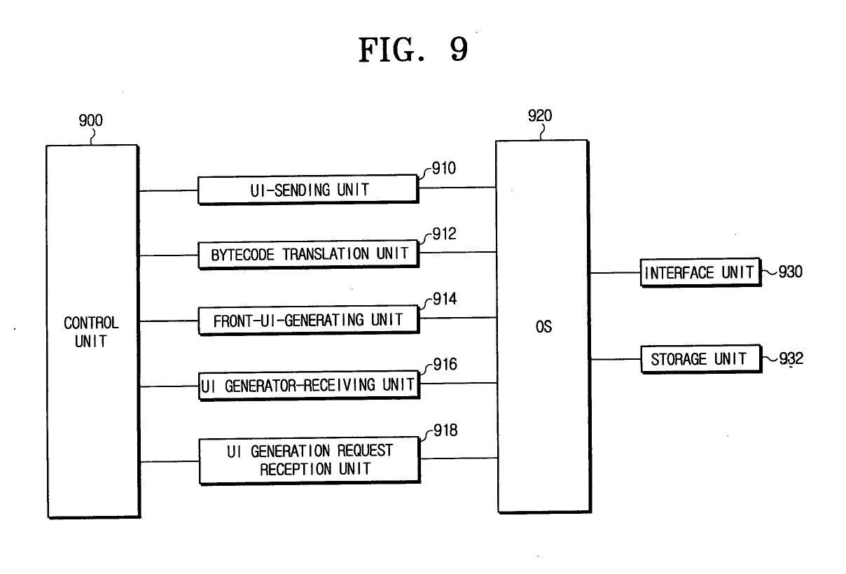

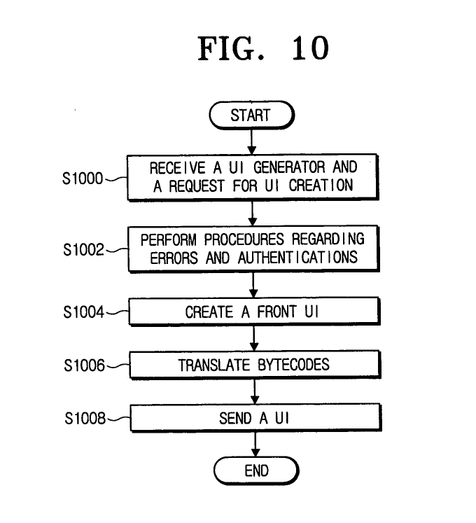

FIG. 9 shows a structure of a UI generation unit according to an exemplary embodiment of the present invention. FIG. 10 shows operations of the UI generation unit.

With reference to FIG. 9, the UI generation unit includes a control unit 900, a UI-sending unit 910, a bytecode translation unit 912, a Front-UI-generating unit 914, a UI generator-receiving unit 916, a UI generation request reception unit 918, OS 920, an interface unit 930, and a storage unit 932.

The control unit 900 controls the respective units constituting the UI generation unit. The UI-sending unit 910 sends a created UI to the service server or to a client. The bytecode translation unit 912 translates received bytecodes into bytecodes that the client can support. The Front-UI-generating unit 914 creates a Front-UI from a received UI representation. The UI generator-receiving unit 916 receives a UI generator from the service server or from the client. The UI generation request reception unit 918 receives a request for UI creation from the service server or from the client.

The OS 920 interfaces between hardware components and application programs. The interface unit 930 connects the UI generation unit to the clients as well as connecting the UI generation unit to the service server. The storage unit 932 may store general information on the UI generation unit, or information necessary for operations of the UI generation unit.

With reference to FIG. 10, in operation S1000, the UI generation unit receives a UI generator, and is requested to create a UI using the UI generator. In operation S1002, the UI generation unit performs procedures regarding errors in and authentications for the received UI generator. That is, the UI generation unit determines whether the received UI generator is sent from a corresponding service server or from a client. In operation S1004, the UI generation unit generates a Front-UI, and in operation S1006, translates bytecodes. In operation S1008, the UI generation unit sends the created UI to the service server or to the client.

As stated above, the present invention enables the service server to provide each of a plurality of clients with a unique user interface and to receive control commands from the clients. Further, if a client can not generate a user interface, the service server or the UI generation unit creates a user interface using a profile received from the client and sends the user interface to the client, thereby reducing the work load of the client.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

1. A method of providing a user interface for a client of a home network, the method comprising:
transmitting a request for a user interface generator from the client to a service server of the home network;
transmitting a client profile from the client to the service server;
receiving at the client a modified user interface generator from the service server, the modified user interface generator suitable for the client profile transmitted to the service server; and
generating a the client a user interface using the modified user interface generator which is received.

2. The method as claimed in claim 1, further comprising, prior to transmitting the client profile, receiving at the client a request for the client profile from the service server.

3. The method as claimed in claim 1, wherein the modified user interface generator comprises:
a user interface representation abstractly coding the user interface; and
bytecodes executable in a virtual machine of the client.

4. The method as claimed in claim 1, wherein the modified user interface generator is created by the service server based on the client profile transmitted by the client.

5. A method of providing a user interface for a client of a home network, the method comprising:
transmitting a request for a user interface from the client to a service server of the home network;
transmitting a client profile from the client to the service server; and
receiving at the client a user interface from the service server, the user interface suitable for the client profile transmitted to the service server.

6. The method as claimed in claim 5, further comprising, prior to transmitting the client profile, receiving at the client a request for a client profile from the service server.

7. The method as claimed in claim 5, further comprising:
receiving at the service server the request for the user interface from the client;
receiving at the service server the client profile from the client;
modifying at the service server a user interface representation in accordance with the client profile received from the client;
transmitting the modified user interface representation from the service server to a user interface generation unit;
receiving at the service server, the user interface from the user interface generation unit; and transmitting the user interface to the client.

8. A method of establishing a user interface, the method comprising:
at the client:
requesting a user interface generator from a service server;
transmitting a client profile to the service server;
receiving a modified user interface generator suitable for the client profile transmitted to the service server;
requesting a user interface from a user interface generation unit;
transmitting the modified user interface generator to the user interface generation unit;
receiving a user interface from the user interface generator.

9. A user interface-providing system comprising:
at least one client which requests a user interface and transmits a client profile;
a service server which requests the generation of a user interface using the client profile; and
a user interface generation unit which creates a user interface in accordance with the client profile.

10. The system as claimed in claim 9, wherein the user interface generation unit sends the user interface to the service server or to the client.

11. The system as claimed in claim 9, wherein the service server sends a modified user interface generator suitable for the client profile to the user interface generation unit.

12. The system as claimed in claim 11, wherein the user interface generation unit generates a user interface by using a user interface generator received from a service server.

13. The system as claimed in claim 6, wherein the client performs authentication procedures regarding a received user interface generator or a received user interface.

14. The system as claimed in claim 10, wherein the user interface generation unit performs authentication procedures regarding the user interface generator.
